(19) United States
(12) Patent Application Publication
(10) Pub. No.: US 2014/0090531 A1
(43) Pub. Date: Apr. 3, 2014

(54) MICROTOME FOR PRODUCING SECTIONS OF SPECIMENS

(71) Applicant: Leica Biosystems Nussloch GmbH, Nussloch (DE)

(72) Inventor: Christoph Schmitt, Schriesheim (DE)

(73) Assignee: Leica Biosystems Nussloch GmbH, Nussloch (DE)

(21) Appl. No.: 14/080,548

(22) Filed: Nov. 14, 2013

Related U.S. Application Data
(63) Continuation of application No. 12/557,363, filed on Sep. 10, 2009.

(30) Foreign Application Priority Data
Sep. 16, 2008 (DE) 10 2008 047 415.0

(51) Int. Cl. G01N 1/42; G01N 1/06

(52) U.S. Cl. CPC G01N 1/42; G01N 1/06
USPC 83/76.8

(57) ABSTRACT

A microtome for producing sections of a specimen having a knife for sectioning the specimen and a cooling apparatus for cooling a gaseous coolant cooling the specimen. A database stores data of various tissue types and target temperatures that are allocated to these various tissue types. A reading unit is adapted to read a code from a specimen or from a specimen carrier unit allocated to the specimen and a control unit is adapted to determine the tissue type of the tissue of the specimen by the code that has been read. The control unit is adapted to read the target temperature of the specimen to be sectioned for controlling the cooling apparatus and setting this target temperature and is adapted to control the cooling apparatus such that the cooling power is controlled to preset target temperature.

### CROSS-REFERENCE TO RELATED APPLICATION

This application is a Continuation Application claiming the benefit of the U.S. non-provisional patent application Ser. No. 12/557,363 that claims the priority of the German patent application DE 102008047415.0 having a filing date of Sep. 16, 2008. The entire content of this prior German patent application DE 102008047415.0 and of the parent application 12/557,363 is herewith incorporated by reference.

### BACKGROUND OF THE INVENTION

The invention relates to a microtome for producing sections of a specimen. The microtome has a knife for sectioning the specimen, and a cooling apparatus for cooling a gaseous coolant.

Microtomes serve generally for the production of thin sections of various prepared specimens, preferably biological prepared specimens. The thin sections are then used for microscopic investigation.

The document DE 20 2005 019 765 U1 discloses a microtome having a cooling device, in which microtome a specimen holder is connected to a coolant circuit of a refrigeration system. Also provided is a thermal conduction plate that can be brought over a specimen to be sectioned and is embodied in cooled fashion. The thermal conduction plate is brought, during sectioning off-times, in front of the specimen to be sectioned so that the specimen is cooled with the aid of the thermal conduction plate. The specimen to be sectioned can have a temperature in the range between −10° C. and −50° C.

The document DE 44 34 937 C1 discloses a microtome having a cryostat chamber and a refrigeration device, in which microtome the cryostat chamber is cooled by the refrigeration device. A temperature regulation device for the specimen receiving unit of a cryostat microtome is furthermore known from the document DE 94 21 559 A1.

When a specimen is sectioned with the aid of a microtome, heat is produced in the cutting operation. In order to cool the specimen during the sectioning operation and between multiple sectioning operations, arrangements for cooling the microtome knife and/or a specimen receiving unit are known. These known arrangements cannot, however, prevent an undesirable amount of heating of the specimen when a relatively high ambient temperature exists in the space surrounding the microtome, and when a plurality of sectioning operations are performed in direct succession in order to produce the sections. The problem occurs in particular with embedded biological samples, in which the medium used for embedding (for example, paraffin) melts or becomes soft at ordinary room temperatures. To allow the generation of high-quality sections, such samples must have, during the sectioning operation, a temperature that is lower than the ambient temperature of the space surrounding the microtome. A sample of this kind should, for example, be sectioned at a temperature in the range between 5° C. and 10° C.

### SUMMARY OF THE INVENTION

It is an object of the invention to describe a microtome in which cooling of the specimen to be sectioned is possible, in simple fashion, even during multiple sectioning operations performed in succession.

The object is achieved by a microtome having the features of Claim 1. Advantageous refinements of the invention are described in the dependent claims.

What is achieved by way of a microtome according to the present invention is that cooling of the specimen takes place even during the sectioning operation and, in particular, the section surface generated on the specimen, which remains in the microtome for further sections, is already cooled immediately after sectioning in order, in particular, to dissipate the heat generated in the sectioning operation. This ensures that the temperature of the specimen, especially at the section surface that has been produced, does not increase so greatly that the medium in which a sample is embedded exhibits modified properties, and high-quality sections cannot be prepared. When paraffin is used as an embedding medium, the specimen to be sectioned exhibits lower strength at a temperature greater than or equal to 20° C. As a result, sections prepared at this specimen temperature cannot be produced with the desired quality. The sample embedded into the embedding medium is, in this context, preferably a biological specimen that is arranged in the microtome as a specimen to be sectioned.

It is advantageous if the specimen is arranged in the coolant flow during sectioning of the specimen. This ensures that the specimen is sufficiently cooled even during the sectioning operation.

It is additionally advantageous to provide partitioning from the environment, and preferably insulation with respect to the environment, at least in the region in which the specimen is arranged during the sectioning operation, so that the coolant flow can be created in simple fashion in this partitioned region. Partitioning of the specimen and, in particular, of the sectioning region produces a climate chamber that is encapsulated with respect to the sectioning region of the microtome.

It is additionally advantageous to convey the gaseous coolant in a coolant circuit. The result is that a gas other than air can be used as a coolant. This gas then does not emerge from microtome 10. It is then only the heat delivered while the coolant is flowing in the coolant circuit that needs to be removed from the gas used as a coolant. Continuous cooling of the coolant, for example from room temperature, is thus not necessary.

The cooling apparatus preferably has a heat exchanger. The coolant flow is preferably conveyed through the heat exchanger in such a way that the heat exchanger removes a quantity of heat from the coolant flow.

The heat exchanger is preferably coupled to at least one Peltier element, the coolant flow being conveyed past the heat exchanger or past the heat sink, serving as a heat exchanger, of cooling elements such as, for example, Peltier elements. A recirculating channel can moreover be provided for conveyance of the coolant, in order to produce the coolant circulation in simple fashion.

It is additionally advantageous if the coolant flow striking the specimen has a lower temperature than the environment of the microtome. The coolant delivered to the specimen preferably has a temperature in the range between 5° C. and 20° C., preferably in the range between 10° C. and 15° C.

The coolant flow can be generated, for example, with the aid of a fan. A flow of gaseous coolant can be produced in simple fashion with the aid of the fan. Using the fan, the coolant is directed via the heat exchanger into the encapsulated region.

The cooling apparatus can furthermore have at least one filter that is arranged downstream from the specimen in the flow direction of the coolant flow. The filter is preferably arranged between the specimen and the fan, or between the specimen and the heat exchanger. The filter can be, for example, a coarse filter to filter out relatively large particles, in particular to filter out sectioning wastes; a fine filter to filter out smaller constituents; and/or a virus filter.

The coolant flow is preferably conveyed in such a way that the coolant is conveyed past both the section surface of the specimen and the knife, and preferably past a knife holder holding the knife, and thereby dissipates heat from the specimen, the knife, and the knife holder. The specimen can be cooled to a preset target temperature by adjusting the cooling output of the heat exchanger and/or by regulating the temperature of the coolant in the coolant flow after the heat exchanger. It is advantageous to adjust the temperature as a function of the embedded sample serving as a specimen, preferably in tissue-specific fashion when tissues are used as samples. A database having various tissue categories, tissue types, and/or tissue names, and target temperatures associated with those tissue types, tissue categories, and/or tissue names, can be provided. A control unit for controlling the cooling apparatus of the microtome can then read out from the database the target temperature for the tissue of the sample presently being sectioned, and preset it as a target temperature. The control unit can then adjust and/or regulate the cooling output of the heat exchanger and/or of cooling elements in accordance with the preset target temperature.

Automatic tissue detection of the tissue of the specimen can preferably be carried out by automatically reading from the specimen or from a specimen carrier unit associated with the specimen, with the aid of a reading unit, a code associated with the tissue or a code for identification of the sample, and identifying the database entry associated with the code in the database or in a further database and reading out from the database information regarding the tissue of the tissue sample. As a result, the tissue sample is uniquely identifiable and the cooling apparatus can cool the specimen being sectioned to the target temperature determined for the tissue in the database or in the further database. The database is preferably a hospital database in which patient data, and the samples taken from the patient, are stored.

### BRIEF DESCRIPTION OF THE DRAWINGS

Further features and advantages of the invention are evident from the description below, which explains the invention in greater detail with reference to an exemplifying embodiment in conjunction with the attached Figures, in which:

FIG. 1 is a partially sectioned perspective depiction of a microtome having a cooling apparatus according to an exemplifying embodiment of the invention;

FIG. 2 is a perspective depiction of the microtome according to FIG. 1 with an air flow, identified by arrows, to cool a specimen being sectioned; and

FIG. 3 shows a closed air circuit, indicated by arrows, in the microtome according to FIGS. 1 and 2, to cool the specimen being sectioned.

### DETAILED DESCRIPTION OF THE DRAWINGS

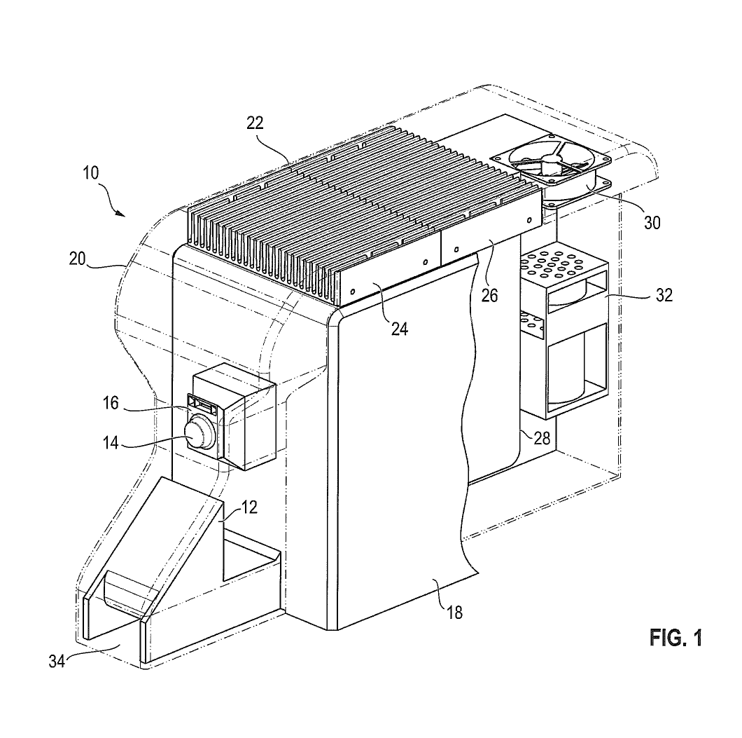

FIG. 1 is a partially sectioned depiction of a microtome 10 having a cooling apparatus according to an embodiment of the invention. In the present exemplifying embodiment microtome 10 is a rotary microtome, in which a stationary knife block 12 and a specimen 14, which is moved relative to knife block 12 in order to produce a section, are provided. Specimen 14 is an embedded biological sample. The sample is preferably embedded in paraffin. Specimen 14 is arranged in a cassette 16 that comprises an identifier, in particular a code for the identification of specimen 14. With the use of the code it is possible in particular for information regarding the origin of the sample, in particular a name of a patient from whom the sample was taken, and further data associated with the sample, to be ascertained in a database and transferred in the form of data to a control unit of microtome 10. Arranged on the upper side of a housing 18 of microtome 10 are Peltier elements 24, 26 having cooling elements to receive a quantity of heat from an air flow conveyed past the cooling elements. The cooling members of Peltier elements 24, 26 are covered with a housing cover 22 that, together with housing 18, forms a closed flow channel through which an air flow is directed past the cooling members of Peltier elements 24, 26 in order to cool specimen 14. This air flow is generated with the aid of a fan 30 that takes in air through a filter module 32. The sectioning region of microtome 10, having knife block 12 and specimen 14, is partitioned off from the environment of microtome 10 by a housing cover 20, housing cover 20 forming, together with housing 18 of microtome 10, a further flow channel region into which the air flow generated by fan 30, which flow is directed past the cooling members of Peltier elements 24, 26, enters and flows past the specimen. The air flowing through the sectioning region is conveyed through an air passthrough opening 34 in the lower region of microtome 10 to filter module 32, thus forming a closed circuit for the air flow. In the present exemplifying embodiment, air has been used as a coolant. Other suitable gases are, however, also usable as a coolant. Especially in the case of gas-tight sealing of the flow channels formed by housing 18 and covers 20, 22, said channels need to be filled with the gas only once. The gas used as a coolant is then transported in the coolant circuit formed by the flow channels, so that only the quantity of heat delivered in the coolant circuit is removed again from the coolant with the aid of

Peltier elements 24, 26. The heat generated by Peltier elements 24, 26 is dissipated to the environment of microtome 10 via heat dissipation channel 28 through outlet openings provided laterally in housing 18 of microtome 10. The outlet openings are provided in that side of housing 18 that is not shown in FIG. 4.

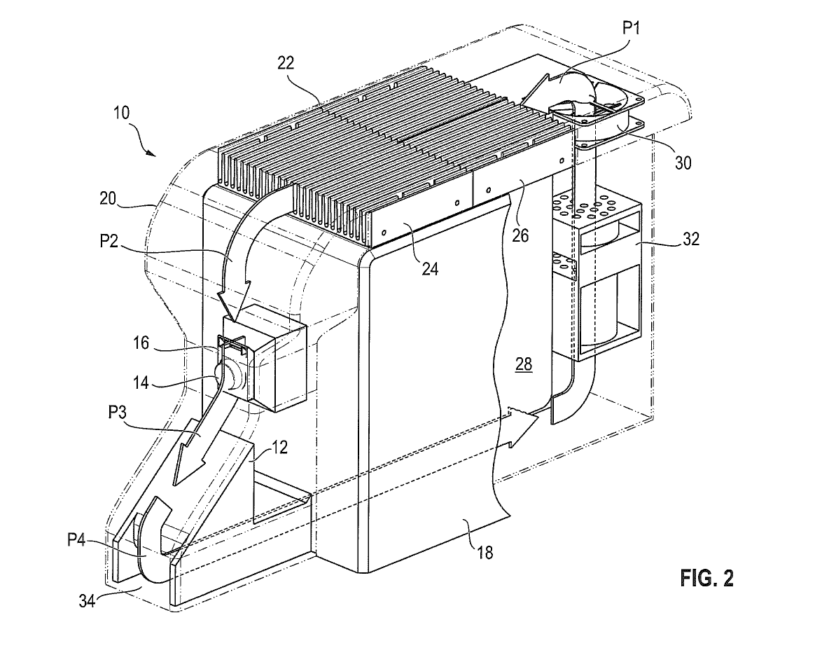

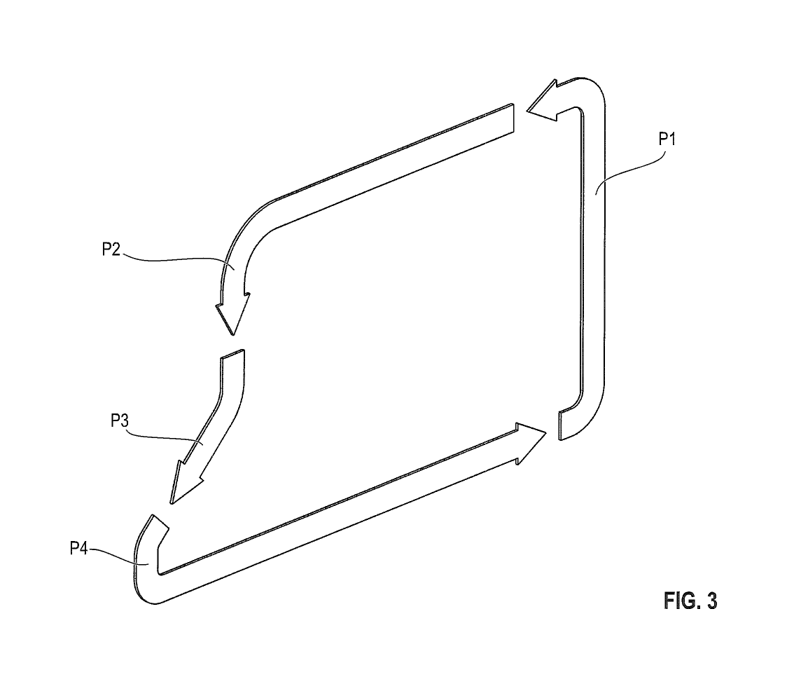

FIG. 2 shows the microtome as depicted in FIG. 1, the air flow generated by fan 30 for cooling specimen 14 being schematically depicted by arrows P1 to P4. Both specimen 14 and knife block 12 are cooled in particular by the air flow, depicted by arrow P3, in the sectioning region of microtome 10. In FIG. 3, the closed air circuit that serves in microtome 10 according to FIGS. 1 and 2 to cool the specimen 10 to be sectioned is depicted by arrows P1 to P4.

In other exemplifying embodiments, microtome 10 can also be embodied as a sliding microtome, ultramicrotome, rocking microtome, saw microtome, disc microtome, vibratome, laser microtome, or laser microdissection system.

The present exemplifying embodiment has described the fact that the sample to be sectioned is embedded in paraffin. In other exemplifying embodiments, embedding media other than paraffin can also be used. When paraffin is used as an embedding medium, specimen 14 to be sectioned should have a temperature in the range between 5 and 20° C., preferably between 10 and 15° C. When embedding media other than paraffin are used, however, different temperatures may also be necessary for optical sectioning quality. The specific target temperature to be preset for specimen 14 for the performance of sectioning operations can also be selected as a function of the specific tissue category or tissue type of the sample, and the embedding medium used.

Suitable target temperatures for particular tissue categories and tissue types, and/or for combinations of embedding media and tissue categories or embedding media and tissue types, can be stored in a database. Depending on the tissue category or tissue type, a suitable target temperature can then be read out of the database and preset as a target value in a control unit of microtome 10. In general, a lower target temperature is to be set for tissue having a high fat concentration than for tissue having a low fat concentration, since the strength of the tissue depends in particular on the fat content.

During sensing of the temperature of specimen 14, or of the temperature in the sectioning region, controlling the temperature to the preset target value can then be performed. Alternatively or additionally, a cooling power of Peltier elements 24, 26 can be controlled to a value correlating with the determined target temperature. Alternatively to Peltier elements 24, 26, different heat exchangers as well as different refrigeration machines can be used to cool the coolant in the coolant circuit, in particular a cooling unit embodied as a heat pump, or a cooling compressor. The refrigeration output to be generated by the Peltier elements 24, 26 or the cooling unit can also be adjusted as a function of the ambient temperature of microtome 10. In other embodiments of the invention, the temperature of the coolant flow downstream from Peltier elements 24, 26 or downstream from the cooling unit can be sensed. Preferably, the cooling output is adjusted and/or regulated as a function of the measured temperature and a preset target temperature. In other exemplifying embodiments of the invention, the sections prepared with the aid of microtome 10 are removed automatically. The result is that housing cover 20 does not need to be taken off in order to remove samples, which would negatively affect the cooling action of the coolant flow. The flow rate generated by fan 30 can also be adjusted in order to adjust the cooling output. Microtome 10 can, in particular, be operated in two modes: in the “trimming” mode for coarse trimming of specimen 14, and in the “sectioning” mode in order to prepare sections for subsequent microscopic investigation of specimen 14. In trimming mode, the cooling apparatus of microtome 10 is adjusted so that only standby cooling is performed. Relatively large section thicknesses are generated in the trimming mode as compared with the sectioning mode, in order to generate a section surface of specimen 14 that is suitable for the sectioning mode. In the sectioning mode, cooling of the section surface of specimen 14 must then be performed in such a way that during a sectioning operation, the temperature of specimen 14 does not exceed a preset target temperature, in order to guarantee the quality of the sections to be prepared subsequently.

Sectioning waste can be sucked off by the air flow generated by fan 30. Flow speeds of more than 20 meters per second are suitable, in particular, for this. Alternatively, a section generated with the aid of microtome 10, or a strip of sections having multiple sections generated with the aid of microtome 10, can be smoothed by means of the air flow generated by fan 30. Flow speeds in the range of 1 or 2 meters per second are suitable, in particular, for this.

### LIST OF REFERENCE NUMERALS

10 Microtome

12 Knife block

14 Specimen

16 Cassette

18 Housing base body, microtome

20 Housing cover, cutting region

22 Housing cover, heat exchanger

24, 26 Peltier elements with cooling members

28 Outlet channel for lateral outlet of heat produced

30 Fan

32 Filter module

34 Air passthrough opening

P1 to P4 Flow arrows

1. A microtome for producing sections of a specimen, comprising:
a knife for sectioning the specimen;
a cooling apparatus for cooling a gaseous coolant, wherein the cooling apparatus generates a coolant flow of the gaseous coolant and the specimen is positionable in that coolant flow;
a database storing data representing various tissue types and target temperatures that are allocated to these various tissue types;
a reading unit adapted to read a code from a specimen or from a specimen carrier unit allocated to the specimen; and
a control unit adapted to determine the tissue type of the tissue of the specimen by the code that has been read; wherein
the control unit is adapted to read the target temperature of the specimen to be sectioned for controlling the cooling apparatus and setting this target temperature; and
the control unit is adapted to control the cooling apparatus such that the cooling power is controlled to preset target temperature.

2. The microtome according to claim 1, wherein the specimen is positionable in the coolant flow during sectioning of the specimen.

3. The microtome according to claim 1, wherein at least a region in which the specimen is positionable is insulated from the environment.

4. The microtome according to claim 1, wherein the coolant is conveyed in a coolant circuit.

5. The microtome according to claim 1, wherein the cooling apparatus comprises a heat exchanger and the coolant flow is conveyed through that heat exchanger such that the heat exchanger draws an amount of heat from the coolant flow.

6. The microtome according to claim 1, wherein the coolant flow impinging on the specimen has a lower temperature than the ambient temperature of the microtome.

7. The microtome according to claim 6, wherein the coolant flow impinging on the specimen has a temperature between 5° C. and 20° C.

8. The microtome according to claim 7, wherein the coolant flow impinging on the specimen has a temperature between 10° C. and 15° C.

9. The microtome according to claim 1, wherein the cooling apparatus comprises a fan for generating a coolant flow.

10. The microtome according to claim 1, wherein the cooling apparatus comprises at least one filter that is provided downstream from the specimen.

11. The microtome according to claim 1, wherein the coolant flow impinges on a section surface of the specimen that was created by a previous sectioning.

12. The microtome according to claim 1, wherein the coolant flow flows closely by a section surface of the specimen that was created by a previous sectioning.
